(19) United States
(12) Patent Application Publication
(10) Pub. No.: US 2025/0138987 A1
(43) Pub. Date: May 1, 2025

(54) EXPERIMENTAL PARAMETER TESTING

(71) Applicant: Lemon Inc., Grand Cayman (KY)

(72) Inventor: Siming Zhao, Los Angeles, CA (US)

(21) Appl. No.: 18/793,751

(22) Filed: Aug. 3, 2024

(30) Foreign Application Priority Data
Oct. 26, 2023 (CN) 202311402354.4

(51) Int. Cl. G06F 11/36

(52) U.S. Cl. CPC G06F 11/3676

(57) ABSTRACT

The disclosure provides a solution for experimental parameter testing. A method includes: determining a traffic indicator of a target object, and obtaining a plurality of traffic indicator values of the traffic indicator from a plurality of databases; determining, based on the plurality of traffic indicator values, a quantile indicator value corresponding to the traffic indicator; obtaining a plurality of first ground-truth indicator values corresponding to an experimental group and a plurality of second ground-truth indicator values corresponding to a control group of a traffic indicator of the plurality of databases; and determining a test result of the experimental parameter based on the plurality of first ground-truth indicator values, the plurality of second ground-truth indicator values and the quantile indicator value, the test result being test passed or test failed.

### CROSS-REFERENCE TO RELATED APPLICATION

This application claims priority to Chinese patent application No. 202311402354.4, filed on Oct. 26, 2023 and entitled “METHOD, APPARATUS, AND ELECTRONIC DEVICE FOR EXPERIMENTAL PARAMETER TESTING”, which is incorporated herein by reference in its entirety.

### FIELD

Embodiments of the present disclosure relate to the field of data processing technology, and in particular, to a method, apparatus, and electronic device for experimental parameter testing.

### BACKGROUND

Before developers add a new function to an application, they need to test the impact of the function on some traffic indicators (such as a startup time).

Currently, since traffic indicators can be stored in different databases, an electronic device can evaluate the traffic indicators based on the average values of the traffic indicators in different databases. However, for the traffic data of traffic indicators stored in quantiles (for example, 50th quantile), the average value cannot accurately reflect the distribution of traffic indicators in each database, and the accuracy of data is low, which leads to the lower accuracy of experimental evaluation.

### SUMMARY

The present disclosure provides a method, apparatus and electronic device for experimental parameter testing to solve one or more technical problems in the prior art.

In a first aspect, the present disclosure provides a method of experimental parameter testing, wherein the method comprises:
determining a traffic indicator of a target object, and obtaining a plurality of traffic indicator values of the traffic indicator from a plurality of databases;
determining, based on the plurality of traffic indicator values, a quantile indicator value corresponding to the traffic indicator;
obtaining a plurality of first ground-truth indicator values corresponding to an experimental group and a plurality of second ground-truth indicator values corresponding to a control group of a traffic indicator of the plurality of databases; and
determining a test result of the experimental parameter based on the plurality of first ground-truth indicator values, the plurality of second ground-truth indicator values and the quantile indicator value, the test result being test passed or test failed.

In a second aspect, the present disclosure provides an apparatus for experimental parameter testing, comprising a first determination module, a first obtaining module, a second determination module, a second obtaining module, and a third determination module, wherein:
the first determination module is configured to determine a traffic indicator of a target object;
the first obtaining module is configured to obtain a plurality of traffic indicator values of the traffic indicator from a plurality of databases;
the second determination module is configured to determine, based on the plurality of traffic indicator values, a quantile indicator value corresponding to the traffic indicator;
the second obtaining module is configured to obtain a plurality of first ground-truth indicator values corresponding to an experimental group and a plurality of second ground-truth indicator values corresponding to a control group of a traffic indicator of the plurality of databases; and
the third determination module is configured to determine a test result of the experimental parameter based on the plurality of first ground-truth indicator values, the plurality of second ground-truth indicator values and the quantile indicator value, the test result being test passed or test failed.

In a third aspect, the present disclosure provides an electronic device comprising a processor and a memory;
the memory storing computer-executable instructions; and
the processor executing the computer-executable instructions stored in the memory, causing the processor to perform the method of experimental parameter testing according to the first aspect and as variously as may be covered in the first aspect.

In a fourth aspect, the present disclosure provides a computer-readable storage medium storing computer-executable instructions, the computer-executable instructions, when executed by a processor, implementing the method of experimental parameter testing according to the first aspect and as variously as may be covered in the first aspect.

The embodiments disclosed herein provide a method, apparatus, and electronic device for experimental parameter testing. The electronic device can determine a traffic indicator of a target object, and obtaining a plurality of traffic indicator values of the traffic indicator from a plurality of databases; determine, based on the plurality of traffic indicator values, a quantile indicator value corresponding to the traffic indicator; obtain a plurality of first ground-truth indicator values corresponding to an experimental group and a plurality of second ground-truth indicator values corresponding to a control group of a traffic indicator of the plurality of databases; and determine a test result of the experimental parameter based on the plurality of first ground-truth indicator values, the plurality of second ground-truth indicator values and the quantile indicator value, the test result being test passed or test failed. In the above method, since the electronic device can accurately determine optimization and degradation results of the experimental parameters on the traffic indicator based on the ground-truth indicator values of the control group and the ground-truth indicator values of the experimental group and in combination with the quantile indicator value, the accuracy of the experiment evaluation can be improved.

### BRIEF DESCRIPTION OF THE DRAWINGS

In order to illustrate the embodiments of the present disclosure or the technical solutions more clearly in the prior art, a brief introduction will be made below to the drawings to be used in the description of the embodiments or the prior art. Obviously, the drawings in the following description are some of the embodiments of the present disclosure, and those of ordinary skill in the art can obtain other drawings based on these drawings without the exercise of any creative effort.

FIG. 1 is a schematic diagram of an application scenario provided by embodiments of the present disclosure;

FIG. 2 is a schematic flowchart of a method of experimental parameter testing provided by embodiments of the present disclosure;

FIG. 3 is a schematic diagram of obtaining business indicator values provided by embodiments of the present disclosure;

FIG. 4 is a schematic diagram of a first real indicator values provided by embodiments of the present disclosure;

FIG. 5 is a schematic diagram of determining a test result provided by embodiments of the present disclosure;

FIG. 6 is a schematic diagram of a method of determining a quantile indicator value provided by embodiments of the present disclosure;

FIG. 7 is a schematic process diagram of a method of experimental parameter testing provided by embodiments of the present disclosure;

FIG. 8 is a schematic structural diagram of an apparatus for experimental parameter testing provided by embodiments of the present disclosure; and

FIG. 9 is a schematic structural diagram of an electronic device provided by embodiments of the present disclosure.

### DETAILED DESCRIPTION

Example embodiments will be described in detail herein, examples of which are illustrated in the accompanying drawings. When the following description involves the drawings, the same numbers in different drawings refer to the same or similar elements unless otherwise indicated. The implementations described in the following example embodiments do not represent all implementations consistent with the present disclosure. On the contrary, they are merely examples of apparatus and methods consistent with aspects of the present disclosure as detailed in the appended claims.

For the sake of understanding, the concepts involved in the embodiments of the present disclosure are explained below.

Terminal device: a device with wireless transceiver functionality. Terminal devices can be deployed on land, comprising indoor or outdoor, handheld, wearable or on-board. The terminal device may be a mobile phone, a tablet computer (Pad), a computer with wireless transceiver functionality, a virtual reality (VR) terminal device, an augmented reality (AR) terminal device, or a wireless terminal in industrial control, an on-board terminal device, a wireless terminal in self-driving, a wireless terminal device in remote medical, a wireless terminal device in smart grid, a wireless terminal device in transportation safety, a wireless terminal device in smart city, a wireless terminal device in smart home, a wearable terminal device, etc. The terminal device involved in the embodiments of the present disclosure can also be called terminal, user equipment (UE), access terminal device, on-board terminal, industrial control terminal, UE unit, UE station, mobile site, mobile station, remote station, remote terminal device, mobile device, UE terminal device, wireless communication device, UE agent or UE apparatus, etc. The terminal device can also be fixed or mobile.

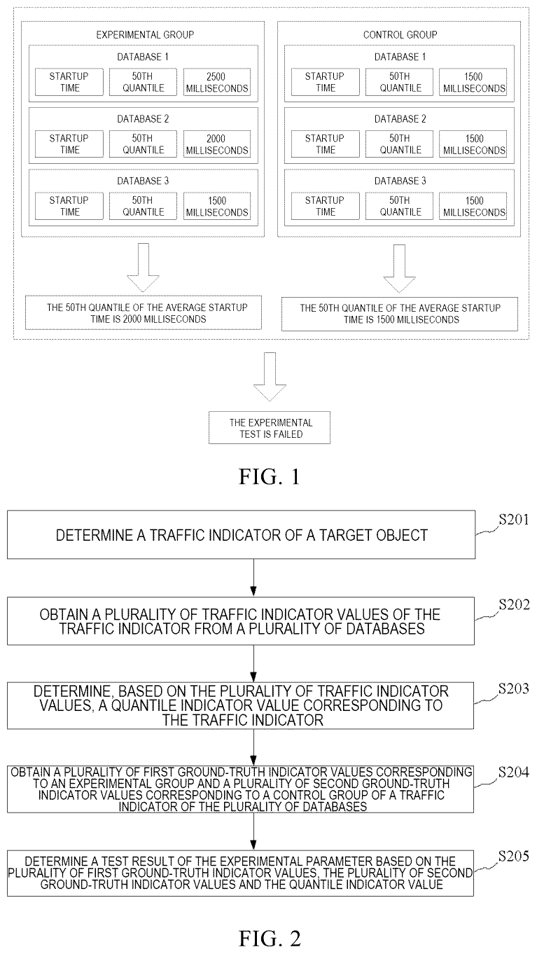

With reference to FIG. 1, the application scenario of the embodiments of the present disclosure will be described below.

FIG. 1 is a schematic diagram of an application scenario provided by embodiments of the present disclosure. With reference to FIG. 1, experimental and control groups are comprised. Both the experimental group and the control group comprise database 1, database 2 and database 3. The 50th quantile corresponding to the startup time in database 1 of the experimental group is 2500 milliseconds, the 50th quantile corresponding to the startup time in database 2 is 2000 milliseconds, and the 50th quantile corresponding to the startup time in database 3 is 1500 milliseconds. The 50th quantile corresponding to the startup time in database 1 of the control group is 1500 milliseconds, the 50th quantile corresponding to the startup time in database 2 is 1500 milliseconds, and the 50th quantile corresponding to the startup time in database 3 is 1500 milliseconds.

Reference is made to FIG. 1. The electronic device can average the 50th quantile startup times in database 1, database 2 and database 3, obtaining 2000 milliseconds for an average 50th quantile startup time of the experimental group and 1500 milliseconds for an average 50th quantile startup time of the control group. Since 2000 milliseconds are greater than 1500 milliseconds, thus the electronic device can determine that the experiment has not optimized the startup time and the experimental fails the test.

It should be noted that FIG. 1 merely depicts an application scenario of the embodiments of the present disclosure by way of example, rather than limiting the application scenarios thereof.

In related arts, developers need to test the impact of a new function on some traffic indicators before adding the function to an application. For example, developers need to optimize the startup time of the application. Therefore, developers can develop a plurality of functions and need to test whether each function has optimized the startup time. Currently, since traffic indicators need to be stored in different data blocks, the electronic device needs to obtain the average values corresponding to the traffic indicators in different data blocks, and then evaluate the experiment based on the average value. For example, if the average startup time before the experiment is 1000 milliseconds and the average startup time after the experiment is 800 milliseconds, the electronic device can determine that the experiment optimizes the startup time. However, the values of part of traffic indicators in the plurality of databases are stored in quantiles. The average value calculated by the electronic device cannot accurately reflect the distribution information indicated by the quantiles. The average-based approach to counting the values of quartiles leads to lower accuracy in the values of traffic indicators, which in turn results in a less accurate evaluation of the experiment.

To solve the technical problems in the related arts, the embodiments of the present disclosure provide a method of experimental parameter testing. The electronic device can determine a traffic indicator of a target object, and obtaining a plurality of traffic indicator values of the traffic indicator from a plurality of databases; determine, based on the plurality of traffic indicator values, a quantile indicator value corresponding to the traffic indicator; obtain a plurality of first ground-truth indicator values corresponding to an experimental group and a plurality of second ground-truth indicator values corresponding to a control group of a traffic indicator of the plurality of databases, calculate a first permeability indicator associated with the experimental group and a second permeability indicator associated with the control group, and if the first permeability indicator is greater than or equal to the second permeability indicator, determine the test result as test failed, if the first permeability indicator is less than the second permeability indicator, determine the test result as test passed. In this way, since the permeability indicator can indicate the proportion of the ground-truth indicator values that satisfy a predetermined magnitude relationship with the quantile indicator value, the impact of sudden changes in the ground-truth indicator value (such as a sudden increase or decrease) on the experimental results can be avoided, and based on the first permeability indicator value and the second permeability indicator value, the electronic device can accurately determine changes in the experimental group associated with the traffic indicators of the plurality of databases compared to the control group, thereby improving the accuracy of the experimental test.

A detailed description is presented below to the technical solution of the present disclosure and how the technical solution of the present disclosure solves the above technical problems by way of specific embodiments, which can be combined with each other. The same or similar concepts or processes may not be repeated in some embodiments. Now the embodiments of the present disclosure will be described with reference to the accompanying drawings.

FIG. 2 is a schematic flowchart of a method of experimental parameter testing provided by embodiments of the present disclosure. With reference to FIG. 2, the method can comprise:

At S201, a traffic indicator of a target object is determined.

The execution body of the embodiments of the present disclosure may be an electronic device or may be an apparatus for determining experimental parameters provided in the electronic device. The apparatus for determining experimental parameters can be implemented based on software, or a combination of software and hardware, which is not limited in the embodiments of the present disclosure. Optionally, the electronic device can be any device with on-end computing capabilities, such as a computer or electronic device, which is not limited in the embodiments of the present disclosure.

Optionally, the target object can be an application to be optimized. For example, if the electronic device optimizes application 1, the target object may be application program 1; if the electronic device optimizes application 2, the target object may be application 2.

Optionally, the target object can also be a function to be optimized. For example, if the electronic device optimizes function 1 in the application, the target object may be function 1, and if the electronic device optimizes function 2 in the application, the target object may be function 2.

It should be noted that the electronic device can determine the target object based on any feasible implementation, and the embodiments of the present disclosure are not intended to limit in this regard.

Optionally, the traffic indicator can be an indicator affected by the experiment in the target object. For example, if the experiment affects the startup time of the application, the traffic indicator can be the startup time of the application. If the experiment affects the playing frame rate of the application, the traffic indicator can be the playing frame rate of the application.

It should be noted that the traffic indicator can be an indicator of any traffic in the application, and the embodiments of the present disclosure are not intended to limit in this regard. Moreover, the electronic device can determine the traffic indicator of the target object based on any feasible implementation, and the embodiments of the present disclosure are not intended to limit in this regard.

At S202, a plurality of traffic indicator values of the traffic indicator are obtained from a plurality of databases.

Herein, the traffic indicator value may be a value corresponding to the traffic indicator. For example, if the traffic indicator is the startup time, the traffic indicator value can be 1000 milliseconds, 2000 milliseconds, 3000 milliseconds, etc.; if the traffic indicator is the playing frame rate, the traffic indicator value can be 30 frames, 60 frames, 120 frames, etc.

Herein, the plurality of traffic indicator values of the traffic indicator can be stored in different databases. For example, the traffic indicator value corresponding to the startup time of Region 1 can be stored in database A, the traffic indicator value corresponding to the startup time of Region 2 can be stored in database B, and the traffic indicator value corresponding to the startup time of Region 3 can be stored in database C.

Optionally, after determining the traffic indicator, the electronic device can obtain traffic indicator values corresponding to the traffic indicator in a plurality of databases. For example, if the traffic indicator is the startup time, the electronic device can determine a plurality of databases in which data about the startup time is stored and obtain the traffic indicator values corresponding to the startup time in the plurality of databases. If the traffic indicator is the playing frame rate, the electronic device can determine a plurality of databases in which data about the playing frame rate is stored and obtain traffic indicator values corresponding to the playing frame rate from the plurality of databases.

It should be noted that the electronic device can determine the database in which data about the traffic indicator is stored based on any feasible implementation, and the embodiments of the present disclosure are not intended to limit in this regard.

Optionally, for any database, the electronic device can input an identifier of the traffic indicator into the database, and then obtain a plurality of traffic indicator values corresponding to the traffic indicator. For example, the database can store a plurality of traffic indicator values corresponding to traffic indicator 1 and a plurality of traffic indicator values corresponding to traffic indicator 2. If the electronic device inputs the identifier of traffic indicator 1 into the database, the electronic device can obtain the plurality of traffic indicator values corresponding to traffic indicator 1 from the database.

It should be noted that the electronic device can also obtain a plurality of traffic indicator values of the traffic indicator from a plurality of databases based on any feasible implementation, and the embodiments of the present disclosure are not intended to limit in this regard.

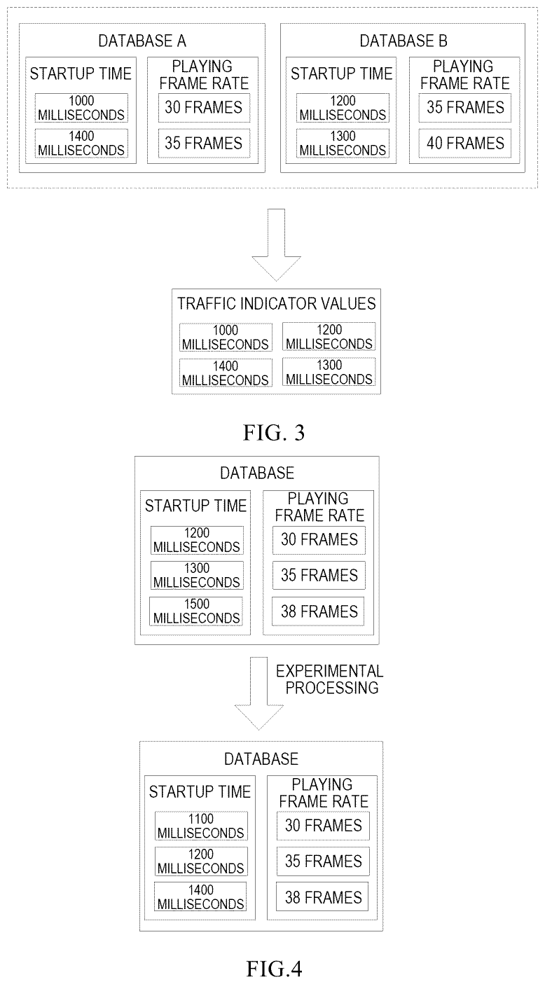

Next, with reference to FIG. 3, illustration is presented below to the process for the electronic device obtaining a plurality of traffic indicator values from a plurality of databases.

FIG. 3 is a schematic diagram of obtaining traffic indicator values provided by embodiments of the present disclosure. The example of FIG. 3 involves database A and database B. Database A comprises a startup time, a playing frame rate, and a plurality of values corresponding to the startup time and a plurality of values corresponding to the playing frame rate. Database B also comprises a startup time, a playing frame rate, and a plurality of values corresponding to the startup time and a plurality of values corresponding to the playing frame rate. If the electronic device (not shown in FIG. 3) determines that the traffic indicator is the startup time, the electronic device can obtain 1000 milliseconds, 1200 milliseconds, 1300 milliseconds and 1400 milliseconds.

At S203, based on the plurality of traffic indicator values, a quantile indicator value corresponding to the traffic indicator is determined.

Optionally, the quantile indicator values can be the 10th quantile indicator value, the 50th quantile indicator value, the 80th quantile indicator value, etc., and the present disclosure is not intended to limit in this regard. For example, if the quantile indicator value is the 50th quantile indicator value, the quantile indicator value can be a median.

For example, if the traffic indicator is the startup time and the quantile indicator value is the 50th quantile indicator value, then the quantile indicator value can be a median of the plurality of traffic indicator values of the startup time obtained from the plurality of databases.

Optionally, the electronic device can determine the quantile indicator value corresponding to the traffic indicator based on the dichotomy method. For example, the electronic device can determine the maximum traffic indicator value and the minimum traffic indicator value among the plurality of traffic indicator values, and then determine the average of the maximum traffic indicator value and the minimum traffic indicator value. With the average as an initial value, the electronic device determines the quantile indicator value among the plurality of traffic indicator values using the dichotomy method.

At S204, a plurality of first ground-truth indicator values corresponding to an experimental group and a plurality of second ground-truth indicator values corresponding to a control group of a traffic indicator of the plurality of databases are obtained.

Optionally, the first ground-truth indicator value may be an indicator value corresponding to the traffic indicator in the experimental group. For example, the experimental group may be a group that conducts experiments on the target object, wherein the electronic device may conduct experiments on the target object based on experimental parameters.

Optionally, the second ground-truth indicator value may be an indicator value corresponding to the traffic indicator in the control group. For example, the control group can be a group that does not conduct experiments on the target object, wherein the electronic device can determine the degree of impact of the experimental parameters on the traffic indicator of the target object based on the data of the control group.

It should be noted that the electronic device can determine the experimental parameters of the target object based on any feasible implementation (such as receiving experimental parameters sent by other device, etc.), and the embodiments of the present disclosure are not intended to limit in this regard.

It should be noted that the electronic device can obtain the plurality of first ground-truth indicator values corresponding to the experimental group and the plurality of second ground-truth indicator values corresponding to the control group based on any feasible implementation (for example, the electronic device can obtain the first ground-truth indicator value and the second ground-truth indicator value in the database), and the embodiments of the present disclosure are not intended to limit in this regard.

Next, with reference to FIG. 4, a detailed description is presented below to the first ground-truth indicator value.

FIG. 4 is a schematic diagram of a first ground-truth indicator value provided by embodiments of the present disclosure. The example of FIG. 4 involves a database where traffic indicators comprised in the database can be startup time and playing frame rate, and traffic indicator values of the startup time are 1200 milliseconds, 1300 milliseconds and 1500 milliseconds, and traffic indicator values of the playing frame rate are 30 frames, 35 frames and 38 frames. After the electronic device (not shown in FIG. 4) conducted an experiment based on the experimental parameters, the traffic indicator values of the startup time in the database are 1100 milliseconds, 1200 milliseconds, and 1400 milliseconds (the plurality of first ground-truth indicator values corresponding to the startup time), and the traffic indicator values of the playing frame rate are 30 frames, 35 frames and 38 frames (the plurality of first ground-truth indicator values corresponding to the playing frame rate).

At S205, a test result of the experimental parameter is determined based on the plurality of first ground-truth indicator values, the plurality of second ground-truth indicator values and the quantile indicator value.

Herein, the test result is test passed or test failed. For example, if the test result is test passed, it means that the experimental parameters can optimize the traffic indicator; if the test result is test failed, it means that the experimental parameters have not optimized the traffic indicator.

Herein, the electronic device can determine the test result of the experimental parameters based on the following feasible implementation: calculating a first permeability indicator associated with the experimental group, calculating a second permeability indicator associated with the control group, and determining the test result of the experimental parameter based on the first permeability indicator and the second permeability indication. In this way, the electronic device can determine the test result of the experiment based on a relationship between the first permeability indicator and the second permeability indicator, thereby improving the accuracy of determining the result of the experiment.

Herein, the first permeability indicator is used to indicate a proportion of first ground-truth indicator values that satisfy a predetermined magnitude relationship with the quantile indicator value. For example, the predetermined magnitude relationship may comprise: the first ground-truth indicator value being greater than or equal to the quantile indicator value, and the first ground-truth indicator value being less than the quantile indicator value. For example, if there are 1,000 first ground-truth indicator values, among which 500 of the first ground-truth indicator values satisfy the predetermined magnitude relationship with the quantile indicator value, then the first permeability indicator may be 50%.

Herein, the second permeability indicator is used to indicate a proportion of second ground-truth indicator values that satisfy a predetermined magnitude relationship with the quantile indicator value. For example, the predetermined magnitude relationship may comprise: the second ground-truth indicator value being greater than or equal to the quantile indicator value, and the second ground-truth indicator value being less than the quantile indicator value. For example, if there are 1,000 second ground-truth indicator values, among which 400 of the second ground-truth indicator values satisfy the predetermined magnitude relationship with the quantile indicator value, then the second permeability indicator may be 40%.

Optionally, the electronic device can calculate the first permeability indicator associated with the experimental group based on the following feasible implementation: obtaining the number of first ground-truth indicator values in each database and adding up the numbers of first ground-truth indicator values in the plurality of databases, to obtain a first number; determining the number of first target indicator values in each database, and adding up the numbers of first target indicator values in the plurality of databases, to obtain a second number; and determining a ratio of the second number to the first number as the first permeability indicator.

Herein, the first target indicator value satisfies a predetermined magnitude relationship with the quantile indicator value. For example, the predetermined magnitude relationship is that the first ground-truth indicator value is greater than or equal to the quantile indicator value. If the first ground-truth indicator value 1 is greater than the quantile indicator value, the electronic device can determine the first ground-truth indicator value 1 as the first target indicator value, and if the first ground-truth indicator value 2 is greater than the quantile indicator value, the electronic device can determine the first ground-truth indicator value 2 as the first target indicator value.

Optionally, the first number may be the sum of the numbers of the first ground-truth indicator values in the plurality of databases. For example, if database A comprises 100 first ground-truth indicator values, database B comprises 300 first ground-truth indicator values, and database C comprises 600 first ground-truth indicator values, then the electronic device can determine the first number to be 1,000.

Optionally, the second number may be the sum of the numbers of the first target indicator values in the plurality of databases. For example, if database A comprises 40 first ground-truth indicator values (the first target indicator values in database A) that satisfy the predetermined magnitude relationship with the quantile indicator value, database B comprises 60 first ground-truth indicator values (the first target indicator values in database B) that satisfy the predetermined magnitude relationship with the quantile indicator value, then the electronic device can determine the second number to be 100.

It should be noted that the electronic device can determine the number of first ground-truth indicator values and the number of first target indicator values in each database based on any feasible implementation, and the embodiments of the present disclosure are not intended to limit in this regard.

Optionally, after the terminal device determines the first number and the second number, the ratio of the second number to the first number may be determined as the first permeability indicator. For example, if the sum of the numbers of first ground-truth indicator values in the plurality of databases is 1,000, and the sum of the numbers of first target indicator values in the plurality of databases is 500, then the first permeability indicator is 50%.

Optionally, the electronic device can determine the first permeability indicator based on the following formula:

$$B = \frac{IF ( X \geq A , 1 , 0 )}{COUNT ( X )}$$

Herein, B can be the first permeability indicator; COUNT (X) is the sum of the numbers (second number) of the first ground-truth indicator values in the plurality of databases; A is the quantile indicator value; X is the first ground-truth indicator value. This formula can represent the proportion of the first ground-truth indicator values that are greater than or equal to the quantile indicator value among the plurality of first true indicator values. In this way, based on the first permeability indicator, changes in the traffic indicator can be accurately reflected, and further the accuracy of experimental testing can be increased.

Optionally, the electronic device can calculate the second permeability indicator associated with the control group based on the following feasible implementation: obtaining the number of second ground-truth indicator values in each database and adding up the numbers of second ground-truth indicator values in the plurality of databases, to obtain a third number; determining the number of second target indicator values in each database, and adding up the numbers of second target indicator values in the plurality of databases, to obtain a fourth number; and determining a ratio of the fourth number to the third number as the second permeability indicator.

Herein, the second target indicator value satisfies a predetermined magnitude relationship with the quantile indicator value. For example, the predetermined magnitude relationship is that the second ground-truth indicator value is greater than or equal to the quantile indicator value. If the second ground-truth indicator value 1 is greater than the quantile indicator value, the electronic device can determine the second ground-truth indicator value 1 as the second target indicator value, and if the second ground-truth indicator value 2 is greater than the quantile indicator value, the electronic device can determine the second ground-truth indicator value 2 as the second target indicator value.

Optionally, the third number may be the sum of the numbers of second ground-truth indicator values in the plurality of databases. For example, if database A comprises 100 second ground-truth indicator values, database B comprises 200 second ground-truth indicator values, and database C comprises 200 second ground-truth indicator values, then the electronic device may determine that the third number is 500.

Optionally, the fourth number may be the sum of the numbers of second target indicator values in the plurality of databases. For example, if database A comprises 10 second ground-truth indicator values (second target indicator values in database A) that satisfy the predetermined magnitude relationship with the quantile indicator value, database B comprises 40 second ground-truth indicator values (second target indicator values in database B) that satisfy the predetermined magnitude relationship with the quantile indicator value, then the electronic device can determine that the fourth number is 50.

It should be noted that the electronic device can determine the number of second ground-truth indicator values and the number of second target indicator values in each database based on any feasible implementation, and the embodiments of the present disclosure are not intended to limit in this regard.

Optionally, after determining the third number and the fourth number, the terminal device can determine the ratio of the fourth number to the third number as the second permeability indicator. For example, if the sum of the numbers of second ground-truth indicator values in the plurality of databases is 1,000, and the sum of the numbers of second target indicator values in the plurality of databases is 400, then the first permeability indicator is 40%.

Optionally, the electronic device can determine the first permeability indicator based on the following formula:

$$C = \frac{IF ( Y \geq A , 1 , 0 )}{COUNT ( Y )}$$

Herein, C can be the second permeability indicator; COUNT (Y) is the sum of the numbers of second true indicator values in the plurality of databases (the fourth number); A is the quantile indicator value; Y is the second ground-truth indicator value. This formula can represent the proportion of the second ground-truth indicator values that are greater than or equal to the quantile indicator value among the plurality of second ground-truth indicator values. Thus, in combination with the first permeability indicator and the second permeability indicator, the electronic device can determine the impact of the experimental group on the traffic indicator and further accurately evaluate the experimental result.

Optionally, the electronic device determines the test result of the experimental parameter based on the first permeability indicator and the second permeability indicator, a specific implementation of which may be: processing the first permeability indicator and the second permeability indicator based on hypothesis testing, to obtain a P value associated with the hypothesis testing; in accordance with a determination that the P value indicates that there is a significant difference between the first permeability indicator and the second permeability indicator, determining the test result of the experimental parameter as test passed.

Herein, the P value is used to indicate whether there is a significant difference between the first permeability indicator and the second permeability indicator. For example, if the P value is greater than or equal to 0.05, the terminal device can determine that there is no significant difference between the first permeability indicator and the second permeability indicator; if the P value is less than 0.05, the terminal device can determine that there is a significant difference between the first permeability indicator and the second permeability indicator.

For example, if there is no significant difference between the first permeability indicator and the second permeability indicator, it means that the electronic device's experiment on the target object has not optimized the traffic indicator. Therefore, the electronic device can determine the test result as test failed.

For example, if there is a significant difference between the first permeability indicator and the second permeability indicator, it means that the electronic device's experiment on the target object has optimized the traffic indicator. Therefore, the electronic device can determine that the test result is test passed.

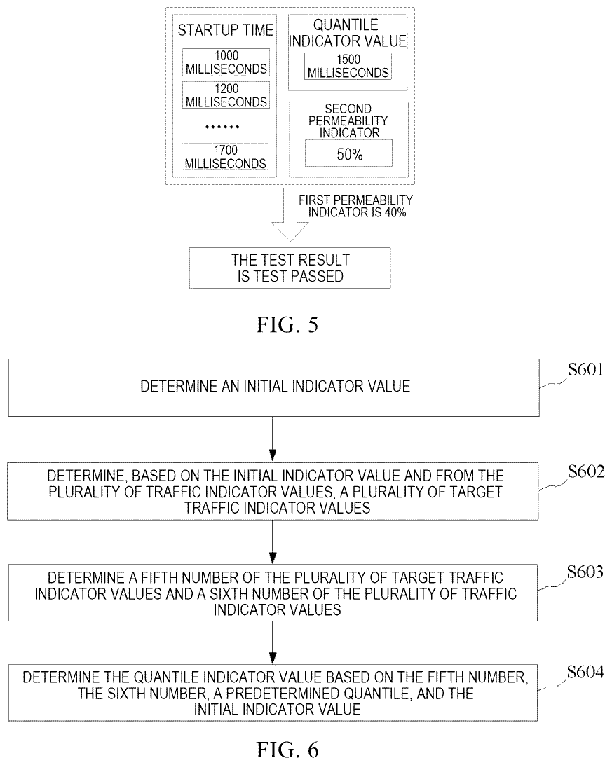

Next, with reference to FIG. 5, a detailed description is presented below to the process for determining the test result.

FIG. 5 is a schematic diagram for determining a test result provided by embodiments of the present disclosure. In the embodiments shown in FIG. 5, the traffic indicator is the startup time. In FIG. 5, the first 1000 ground-truth indicator values corresponding to the startup time are 1000 milliseconds, 1200 milliseconds, . . . , 1700 milliseconds. Herein, the quantile indicator value is 1500 milliseconds, the second permeability indicator is 50%, the electronic device determines that the number of startup times greater than 1500 milliseconds is 400, and the first permeability indicator is 40%. Therefore, the electronic device can determine that the experiment has optimized the startup time (with a significant difference), and further determine that the test result is test passed.

Optionally, after the electronic device determines the test result of the experimental parameters, if the test result is test failed, prompt information is generated and sent to a predetermined device, or the prompt information is presented.

Optionally, the prompt information is used to indicate a risk of online operation for the experimental parameter. For example, in the process of actual application, after the electronic device determines the test result of the experimental parameters as test failed, the electronic device can generate prompt information indicating that the experiment has degraded the traffic indicator, and then prompt the user that the experiment contains the risk of degrading the traffic indicator after going online. For example, the electronic device, after generating the prompt information, can send the prompt information to the predetermined device. The predetermined device can be any device determined in advance, and the embodiments of the present disclosure are not intended to limit in this regard. For example, the electronic device, after generating prompt information, can also present the prompt information and further remind the user that the experiment has the risk of degrading the traffic indicator, thereby improving the reliability of the experiment.

Optionally, after the electronic device determines the test result as test failed, the electronic device can calculate the quantile of the traffic indicator values of the traffic indicator in each database and generate an associated prompt information to prompt that the traffic indicator will be degraded by the experimental parameters. For example, if the electronic device determines that the experimental parameters will increase the value of the startup time, the electronic device can calculate the 50th quantile of the startup time in database A and generate prompt information, and the electronic device can calculate the 50th quantile of the startup time in database B and generate prompt information.

The embodiments disclosed provide a method of experimental parameter testing. The electronic device can determine a traffic indicator of a target object, and obtaining a plurality of traffic indicator values of the traffic indicator from a plurality of databases; determine, based on the plurality of traffic indicator values, a quantile indicator value corresponding to the traffic indicator; obtain a plurality of first ground-truth indicator values corresponding to an experimental group and a plurality of second ground-truth indicator values corresponding to a control group of a traffic indicator of the plurality of databases, calculate a first permeability indicator associated with the experimental group and a second permeability indicator associated with the control group, and if the first permeability indicator is greater than or equal to the second permeability indicator, determine the test result as test failed, if the first permeability indicator is less than the second permeability indicator, determine the test result as test passed. In this way, since the permeability indicator can indicate the proportion of the ground-truth indicator values that satisfy a predetermined magnitude relationship with the quantile indicator value, based on a magnitude relationship between the first permeability indicator value and the second permeability indicator value, the electronic device can accurately determine changes in the traffic indicator of the experimental group in the plurality of databases and further improve the accuracy of the experimental test.

On the basis of the embodiment shown in FIG. 2 and in combination with FIG. 6 below, description is presented to a method of determining the quantile indicator value corresponding to the traffic indicator based on the plurality of traffic indicator values in the above method of experimental parameter testing.

FIG. 6 is a schematic diagram of a method of determining a quantile indicator value provided by embodiments of the present disclosure. With reference to FIG. 6, the method flow comprises:

At S601, an initial indicator value is determined.

Optionally, the electronic device can determine an initial indicator value based on the maximum traffic indicator value and the minimum traffic indicator value. For example, the electronic device may determine the average of the maximum traffic indicator value and the minimum traffic indicator value of the traffic indicator as the initial indicator value. For example, if the traffic indicator values of the startup time in database A are 1000 milliseconds and 1500 milliseconds, and the traffic indicator values of the startup time in database B are 2000 milliseconds and 1300 milliseconds, then the electronic device can determine that the maximum traffic indicator value of the startup time is 2000 milliseconds, the minimum traffic indicator value is 1000 milliseconds, and the electronic device can determine the initial indicator value to be 1500 milliseconds (the average of 2000 milliseconds and 1000 milliseconds).

Optionally, the electronic device can determine the initial indicator value based on the plurality of traffic indicator values by using any other feasible implementation, and the embodiments of the present disclosure are not intended to limit in this regard.

At S602, based on the initial indicator value and from the plurality of traffic indicator values, a plurality of target traffic indicator values are determined.

Herein, the target traffic indicator value can satisfy a predetermined magnitude relationship with the initial indicator value. For example, the predetermined magnitude relationship may be that the target traffic indicator value is greater than or equal to the initial indicator value, and the predetermined magnitude relationship may be that the target traffic indicator value is less than the initial indicator value. The embodiments of the present disclosure are not intended to limit in this regard.

For example, the predetermined magnitude relationship is that the target traffic indicator value is greater than or equal to the initial indicator value. If the traffic indicator value A, the traffic indicator value B, and the traffic indicator value C are greater than the initial indicator value, the electronic device can determine the traffic indicator value A, the traffic indicator value B and traffic indicator value C as the target traffic indicator values. For example, the predetermined magnitude relationship is that the target traffic indicator value is less than the initial indicator value, the traffic indicator is the startup time, and the initial indicator value is 1000 milliseconds. If the traffic indicator value A is 1200 milliseconds, the traffic indicator value B is 1300 milliseconds, and the traffic indicator value C is 600 milliseconds, the electronic device can determine the traffic indicator value C as the target traffic indicator value.

It should be noted that the electronic device can also determine the target traffic indicator value based on any other feasible implementation, and the embodiments of the present disclosure are not intended to limit in this regard.

At S603, a fifth number of the plurality of target traffic indicator values and a sixth number of the plurality of traffic indicator values are determined.

Herein, the fifth number may be the number of target traffic indicator values. For example, the number of traffic indicator values of the traffic indicator is 1000. If 500 traffic indicator values and the initial indicator value satisfy a predetermined magnitude relationship, the electronic device can determine that the fifth number of target traffic indicator values is 500. If 800 traffic indicator values and the initial indicator value satisfy the predetermined magnitude relationship, the electronic device can determine that the fifth number of target traffic indicator values is 800.

It should be noted that the electronic device can determine the fifth number of target traffic indicator values based on any feasible implementation, and the embodiments of the present disclosure are not intended to limit in this regard.

Optionally, the sixth number may be the number of the plurality of traffic indicator values. For example, during the actual application, if the number of traffic indicator values of the traffic indicator determined by the electronic device in a plurality of databases is 1,000, the electronic device may determine the sixth number to be 1,000. For example, if there are 100 traffic indicator values for the startup time in database A, 900 traffic indicator values for the startup time in database B, and 500 traffic indicator values for the startup time in database C, the electronic device can determine the sixth number of the traffic indicator values of the startup time to be 1500.

It should be noted that the electronic device can determine the sixth number of traffic indicator values based on any feasible implementation, and the embodiments of the present disclosure are not intended to limit in this regard.

At S604, the quantile indicator value is determined based on the fifth number, the sixth number, a predetermined quantile, and the initial indicator value.

Optionally, the predetermined quantile can be a value set based on the quantile indicator value. For example, if the quantile indicator value is the 10th quantile indicator value, the electronic device can determine that the predetermined quantile is 10%, and if the quantile indicator value is the 50th quantile indicator value, the electronic device can determine that the predetermined quantile is 50%.

Herein, the electronic device can determine the quantile indicator value based on the following feasible implementation: determining a ratio between the fifth number and the sixth number; in response to determining that the ratio is equal to the predetermined quantile, determining the initial indicator value as the quantile indicator value; and in response to determining that the ratio is not equal to the predetermined quantile, updating the initial indicator value until the ratio determined based on the updated initial indicator value is equal to the predetermined quantile, and determining the updated initial indicator value as the quantile indicator value.

Herein, the ratio between the fifth number and the sixth number may be a ratio between the number of target traffic indicator values and the number of traffic indicator values. For example, the ratio can be the proportion of the target traffic indicator values in the traffic indicator values. For example, if the fifth number of the target traffic indicator values is 500 and the sixth number of the traffic indicator values is 1000, the electronic device may determine that the proportion of the target traffic indicator values in the traffic indicator values is 50%.

Optionally, if the ratio between the fifth number and the sixth number is equal to the predetermined quantile, the electronic device may determine the initial indicator value as the quantile indicator value. For example, if the quantile indicator value is the 50th quantile indicator value, the predetermined quantile may be 50%. If the ratio is equal to 50%, the electronic device may determine the initial indicator value as the quantile indicator value. For example, the quantile indicator value is the 50th quantile indicator value, the traffic indicator is the startup time, and the initial indicator value determined by the electronic device is 1500 milliseconds. If the number of target traffic indicator values greater than or equal to 1500 milliseconds is 500, and the number of traffic indicator values is 1,000, the electronic device can determine that the second ratio is 50% (equal to the predetermined quantile), and then determine that the quantile indicator value is 1,500.

It should be noted that in the embodiments of the present disclosure, if the ratio is within a predetermined range of the predetermined quantile, the electronic device can also determine the initial indicator value as the quantile indicator value. For example, the predetermined quantile is 50%, and the ratio between the fifth number and the sixth number determined by the electronic device based on the initial indicator value is 49.5%. The electronic device may also determine the initial indicator value as the quantile indicator value.

Optionally, if the ratio between the fifth number and the sixth number is not equal to the predetermined quantile, the electronic device can update the initial indicator value until the ratio obtained based on the updated initial indicator value is determined to be equal to the predetermined quantile, and then determine the updated initial indicator value as the quantile indicator value. For example, if the ratio between the fifth number and the sixth number is not equal to the predetermined quantile, the electronic device needs to update the initial indicator value. After the update, the ratio between the fifth number and the sixth number can be recalculated based on the updated initial indicator value. If the ratio is equal to the predetermined quantile, the electronic device can determine the updated initial indicator value as the quantile indicator value. For example, the quantile indicator value is the 50th quantile indicator value, the traffic indicator is the startup time, and the initial indicator value determined by the electronic device is 1500 milliseconds. If the number of target traffic indicator values greater than or equal to 1500 milliseconds is 300, the number of traffic indicator values is 1000, then the electronic device can determine that the ratio between the fifth number and the sixth number is 30% (not equal to the predetermined quantile), and the electronic device can update 1500 milliseconds to 1000 milliseconds. If the number of target traffic indicator values greater than or equal to 1000 milliseconds is 500, then the electronic device can determine that the ratio between the fifth number and the sixth number is 50% (equal to the predetermined quantile), and then determine 1000 milliseconds as the quantile indicator value. In this way, the accuracy of the determined quantile indicator value can be increased, which in turn can improve the testing accuracy of experimental parameters.

Optionally, the electronic device can update the initial indicator value based on the following feasible implementation methods: if the ratio between the fifth number and the sixth number is less than the predetermined quantile, the electronic device can reduce the initial indicator value. If the fifth number If the ratio between the sixth number and the sixth number is greater than the predetermined quantile, the electronic device can increase the initial indicator value.

Optionally, if the ratio between the fifth number and the sixth number is less than the predetermined quantile, it means that the initial indicator value is higher, and the number of target traffic indicator values greater than or equal to the initial indicator value is smaller. Therefore, the electronic device can reduce the initial indicator value, which in turn can make more traffic indicator values satisfy the predetermined magnitude relationship and improve the accuracy of the quantile indicator value. For example, the traffic indicator is startup time, and the predetermined quantile is 50%. If the initial indicator value is 1500 milliseconds, the number of startup times greater than or equal to 1500 milliseconds is 300, and the total number of startup times is 1000, then the electronic device can determine the ratio between the fifth number and the sixth number is 30%. Further, it can be determined that the initial indicator value is too large, and then the electronic device can update the initial indicator value to 1000 milliseconds. If the number of startup times greater than or equal to 1000 milliseconds is 500, then the electronic device can determine that the ratio is equal to the predetermined quantile, and then determine 1000 milliseconds as the quantile indicator value.

Optionally, if the ratio between the fifth number and the sixth number is greater than the predetermined quantile, it means that the initial indicator value is lower, and the number of target traffic indicator values greater than or equal to the initial indicator value is quite large. Therefore, the electronic device can increase the initial indicator value, thereby making fewer traffic indicator values satisfy the predetermined magnitude relationship and improving the accuracy of the quantile indicator value. For example, the traffic indicator is startup time, and the predetermined quantile is 50%. If the initial indicator value is 1500 milliseconds, the number of startup times greater than or equal to 1500 milliseconds is 700, and the total number of startup times is 1000, then the electronic device can determine the ratio is 70%. Further, it can be determined that the initial indicator value is too small, and the electronic device can update the initial indicator value to 2000 milliseconds. If the number of startup times greater than or equal to 2000 milliseconds is 500, the electronic device can determine that the ratio is equal to predetermined quantile, and then determine 2000 milliseconds as the quantile indicator value.

It should be noted that the method of increasing or reducing the initial indicator value by the electronic device is related to the predetermined magnitude relationship and is also related to the optimization and deterioration of the traffic indicator and the change of the traffic indicator value. For example, if the predetermined magnitude relationship is that the target traffic indicator value is less than the initial traffic indicator value, then the ratio between the fifth number and the sixth number is less than the predetermined quantile, and then the initial indicator value is increased; if the ratio between the fifth number and the sixth number is greater than the predetermined quantile, then the initial indicator value is reduced. For example, if the predetermined magnitude relationship is that the target traffic indicator value is greater than or equal to the initial indicator value, and the traffic indicator is the playing frame rate (the higher the playing frame rate, the better the optimization), then the ratio between the fifth number and the sixth number is less than the predetermined quantile, then the initial indicator value will be increased; and if f the ratio between the fifth number and the sixth number is greater than the predetermined quantile, the initial indicator value will be reduced.

It should be noted that the electronic device can determine the update size of each update of the initial indicator value based on any feasible implementation (e.g., based on the dichotomy method, etc.), and the embodiments of the present disclosure are not intended to limit in this regard.

Embodiments of the present disclosure provides a method of determining a quantile indicator value, wherein the method determines an initial indicator value, determines, based on the initial indicator value and from the plurality of traffic indicator values, a plurality of target traffic indicator values, determines the fifth number of the plurality of target traffic indicator values and the sixth number of the plurality of traffic indicator values, determines a ratio between the fifth number and the sixth number, if the ratio is equal to a predetermined quantile, then determines the initial indicator value as a quantile indicator value, and if the ratio is not equal to the predetermined quantile, then updates the initial indicator value until the ratio determined based on the updated initial indicator value is equal to the predetermined quantile, and then determines the updated initial indicator value as the quantile indicator value. In this way, the electronic device can determine the quantile indicator value associated with the plurality of traffic indicator values based on the dichotomy method, thereby improving the accuracy of determining the quantile indicator value and increasing the accuracy of the experimental test.

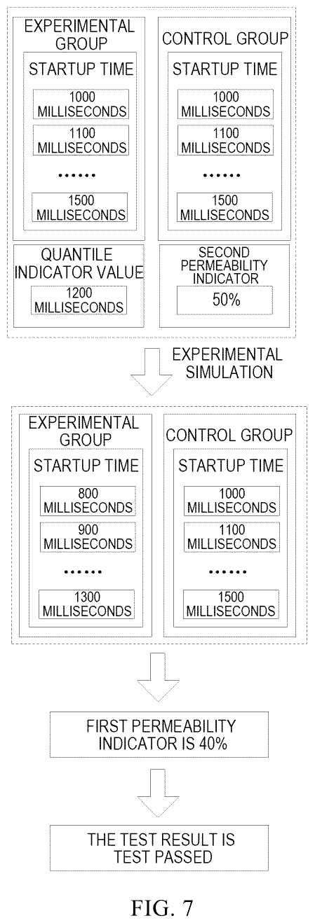

Based on any of the above embodiments and in conjunction with FIG. 7, illustration is presented below to the process for testing the above experimental parameters.

FIG. 7 is a schematic diagram of the process of a method of experimental parameter testing provided by embodiments of the present disclosure. In FIG. 7, a control group and an experimental group that has not undergone the experiment. The database in the control group comprises the startup time, and the traffic indicator values of the startup time comprise 1000 milliseconds, 1100 milliseconds, . . . , 1500 milliseconds (1000). The database in the experimental group comprises the startup time, and the traffic indicator values of the startup time comprise 1000 milliseconds, 1100 milliseconds, . . . , 1500 milliseconds (before the experiment, the traffic indicator values of the startup time of the experimental group are the same as those of the control group).

Reference is made to FIG. 7. The electronic device can determine that the quantile indicator value of the startup time in the experimental group and the control group is 1200 milliseconds, and the second permeability indicator of the control group is 50%. The electronic device can conduct experiments on the experimental group based on the experimental parameters and then update the traffic indicator values of the startup time in the experimental group.

Reference is made to FIG. 7. The traffic indicator values of the startup time in the updated experimental group comprise 800 milliseconds, 900 milliseconds, . . . , 1300 milliseconds. The electronic device can determine that the number of the startup times greater than or equal to 1200 milliseconds is 400, and the first permeability indicator of the experimental group is 40%. Since the first permeability indicator of the experimental group is smaller than the second permeability indicator of the control group, it means that the traffic indicator values of the startup time decrease as a whole after the experiment. Therefore, the electronic device can determine the test result of the experiment as test passed (i.e., the experiment has optimized the startup time). In this way, since the permeability indicator range is 0-1 (the value is a ratio), it is less affected by mutation data and also comprises distribution information. Therefore, the electronic device can accurately determine the test result of the experiment and improve the test accuracy.

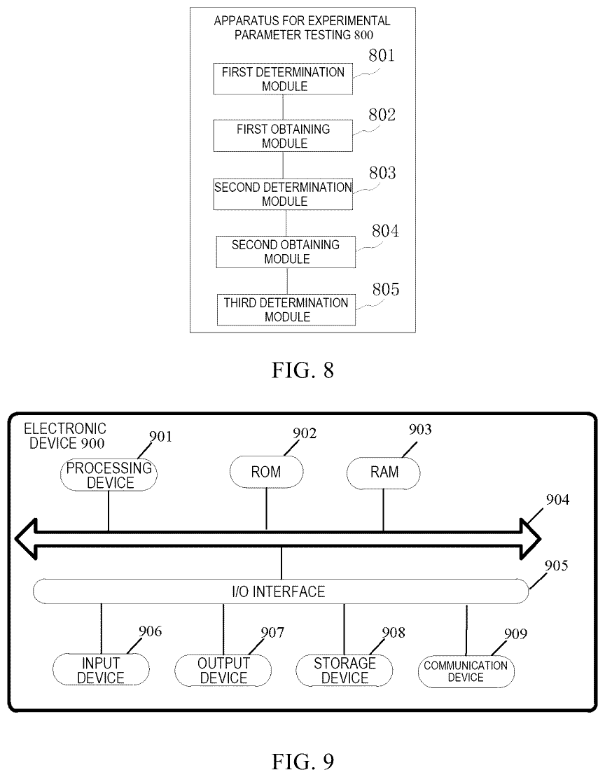

FIG. 8 is a schematic structural diagram of an apparatus for experimental parameter testing provided by embodiments of the present disclosure. Reference is made to FIG. 8, the apparatus for experimental parameter testing 800 comprises a first determination module 801, a first obtaining module 802, a second determination module 803, a second obtaining module 804, and a third determination module 805, wherein:
the first determination module 801 is configured to determine a traffic indicator of a target object;
the first obtaining module 802 is configured to obtain a plurality of traffic indicator values of the traffic indicator from a plurality of databases;
the second determination module 803 is configured to determine, based on the plurality of traffic indicator values, a quantile indicator value corresponding to the traffic indicator;
the second obtaining module 804 is configured to obtain a plurality of first ground-truth indicator values corresponding to an experimental group and a plurality of second ground-truth indicator values corresponding to a control group of a traffic indicator of the plurality of databases; and
the third determination module 805 is configured to determine a test result of the experimental parameter based on the plurality of first ground-truth indicator values, the plurality of second ground-truth indicator values and the quantile indicator value, the test result being test passed or test failed.

According to one or more embodiments of the present disclosure, the third determination module 805 is specifically configured to:
calculate a first permeability indicator associated with the experimental group, to indicate a proportion of first ground-truth indicator values that satisfy a predetermined magnitude relationship with the quantile indicator value;
calculate a second permeability indicator associated with the control group, to indicate a proportion of second ground-truth indicator values that satisfy a predetermined magnitude relationship with the quantile indicator value; and
determine the test result of the experimental parameter based on the first permeability indicator and the second permeability indicator.

According to one or more embodiments of the present disclosure, the third determination module 805 is specifically configured to:
obtain the number of first ground-truth indicator values in each database and add up the numbers of first ground-truth indicator values in the plurality of databases, to obtain a first number;
determine the number of first target indicator values in each database that satisfy a predetermined magnitude relationship with the quantile indicator value, and add up the numbers of first target indicator values in the plurality of databases, to obtain a second number; and
determine a ratio of the second number to the first number as the first permeability indicator.

According to one or more embodiments of the present disclosure, the third determination module 805 is specifically configured to:
obtain the number of second ground-truth indicator values in each database and adding up the numbers of second ground-truth indicator values in the plurality of databases, to obtain a third number;
determine the number of second target indicator values in each database that satisfy a predetermined magnitude relationship with the quantile indicator value, and add up the numbers of second target indicator values in the plurality of databases, to obtain a fourth number; and
determine a ratio of the fourth number to the third number as the second permeability indicator.

According to one or more embodiments of the present disclosure, the third determination module 805 is specifically configured to:
process the first permeability indicator and the second permeability indicator based on hypothesis testing, to obtain a P value associated with the hypothesis testing, the P value indicating whether there is a significant difference between the first permeability indicator and the second permeability indicator; and
in accordance with a determination that the P value indicates that there is a significant difference between the first permeability indicator and the second permeability indicator, determine the test result of the experimental parameter as test passed.

According to one or more embodiments of the present disclosure, the second determination module 803 is specifically configured to:
determine an initial indicator value;
determine, based on the initial indicator value and from the plurality of traffic indicator values, a plurality of target traffic indicator values that satisfy a predetermined magnitude relationship with the initial indicator value;
determine a fifth number of the plurality of target traffic indicator values and a sixth number of the plurality of traffic indicator values;
and determine the quantile indicator value based on the fifth number, the sixth number, a predetermined quantile, and the initial indicator value.

According to one or more embodiments of the present disclosure, the second determination module 803 is specifically configured to:
determine a ratio between the fifth number and the sixth number;
in response to determining that the ratio is equal to the predetermined quantile, determine the initial indicator value as the quantile indicator value; and
in response to determining that the ratio is not equal to the predetermined quantile, update the initial indicator value until the ratio determined based on the updated initial indicator value is equal to the predetermined quantile, and determine the updated initial indicator value as the quantile indicator value.

According to one or more embodiments of the present disclosure, the third determination module 805 is further configured to:
if the test result is test failed, generate prompt information indicating a risk of online operation for the experimental parameter; and
send the prompt information to a predetermined device or present the prompt information.

The apparatus for experimental parameter testing provided by embodiments of the present disclosure can be used to execute the technical solutions of the method embodiments described above, which are similar in terms of realization principle and technical effect, and which will not be repeated herein in the present embodiments.

Reference is made to FIG. 9, which shows a schematic structural diagram of an electronic device 900 suitable for implementing embodiments of the present disclosure. The electronic device may comprise, without limitation to, a mobile terminal such as a mobile phone, a laptop computer, a digital broadcast receiver, a personal digital assistant (abbreviated as PDA), a portable Android device (abbreviated as PAD), a portable multimedia player (abbreviated as PMP), an on-board terminal (e.g., on-board navigation terminal) and the like, as well as a fixed terminal such as a digital TV, a desktop computer and the like. The electronic device shown in FIG. 9 is merely an example and should not be construed to impose any limitations on the functionality and use scope of the embodiments of the present disclosure.

As shown in FIG. 9, the electronic device 900 may comprises a processing device (e.g., a central processor, a graphics processor) 901 which is capable of performing various appropriate actions and processes in accordance with programs stored in a read only memory (ROM) 902 or programs loaded from a storage device 908 to a random access memory (RAM) 903. In the RAM 903, there are also stored various programs and data required by the electronic device 900 when operating. The processing device 901, the ROM 902 and the RAM 903 are connected to one another via a bus 904. An input/output (I/O) interface 905 is also connected to the bus 904.

Usually, the following units may be connected to the I/O interface 905: an input device 906 comprising a touch screen, a touch pad, a keyboard, a mouse, a camera, a microphone, an accelerometers, a gyroscope, or the like; an output device 907, such as a liquid-crystal present (LCD), a loudspeaker, a vibrator, or the like; a storage device 908, such as a magnetic tape, a hard disk or the like; and a communication device 909. The communication device 909 allows the electronic device 900 to perform wireless or wired communication with other device so as to exchange data with other device. While FIG. 9 shows the electronic device 900 with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program comprising program codes for executing the method shown in the flowchart. In such an embodiment, the computer program may be loaded and installed from a network via the communication device 909, or installed from the storage device 908, or installed from the ROM 902. The computer program, when executed by the processing device 901, performs the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may comprise, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium comprising or storing a program that may be used by or in conjunction with an instruction executing system, apparatus, or device. In the present disclosure, the computer readable signal medium may comprise data signals propagated in the baseband or as part of the carrier waveform, in which computer readable program code is carried. Such propagated data signals may take a variety of forms, comprising without limitation to electromagnetic signals, optical signals, or any suitable combination of the foregoing. The computer readable signal medium may also be any computer readable medium other than a computer readable storage medium that may send, propagate, or transmit a program for use by, or in conjunction with, an instruction executing system, apparatus, or device. The program code contained on the computer readable medium may be transmitted by any suitable medium, comprising, but not limited to, a wire, a fiber optic cable, RF (radio frequency), etc., or any suitable combination thereof.

The above computer-readable medium may be contained in the above electronic device; or it may exist separately and not be assembled into the electronic device.

The above computer-readable medium carries one or more programs which, when executed by the electronic device, cause the electronic device to perform the method described in the above embodiments.

The embodiments of the present disclosure provide a computer-readable storage medium, storing computer executable instructions thereon which, when executed by a processor, implement various possible methods involved in the above embodiments.

The embodiments of the present disclosure provide a computer program product, comprising a computer program which, when executed by a processor, implements various possible methods involved in the above embodiments.

Computer program code for carrying out operations of the present disclosure may be written in one or more program designing languages or a combination thereof, which comprise without limitation to an object oriented programming language such as Java, Smalltalk, C++, or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Units involved in the embodiments of the present disclosure as described may be implemented in software or hardware. The name of a unit does not form any limitation on the module itself. For example, a first obtaining unit may further be described as “a unit configured for obtaining at least two Internet Protocol addresses”.

The functionality described above may at least partly be performed, at least in part, by one or more hardware logic components. For example and in a non-limiting sense, example types of hardware logic components that can be used comprise: field-programmable gate arrays (FPGA), application specific integrated circuits (ASICs), application specific standard products (ASSPs), systems on chips (SOCs), complex programmable logic devices (CPLDs), etc.

In the context of the present disclosure, the machine readable medium may be a tangible medium that can retain and store programs for use by or in conjunction with an instruction execution system, apparatus, or device. The machine readable medium of the present disclosure can be a machine readable signal medium or a machine readable storage medium. The machine readable medium may comprise, but is not limited to, an electronic, magnetic, optical, electromagnetic, infrared or semiconductor system, apparatus or device, or any combination of the foregoing. More specific examples of the machine readable storage medium may comprise, without limitation to, the following: an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

It should be noted that the modifications of “one” and “plurality” mentioned herein are illustrative and non-limiting. Those skilled in the art will understand that unless otherwise clearly indicated in the context, the modifications should be understood as “one or more”.

The names of messages or information exchanged between a plurality of devices in the embodiments of the present disclosure are for illustrative purposes only, rather than limiting the scope of these messages or information.

It can be understood that before using the technical solution disclosed in each embodiment of the present disclosure, users should be informed of the type, scope of use, usage scenarios and the like of the personal information involved in the present disclosure in an appropriate manner in accordance with relevant laws and regulations, and their authorization should be obtained.

For example, in response to receiving an active request from a user, prompt information is sent to the user to clearly remind the user that the operation requested will need to obtain and use the user's personal information. Therefore, the user can autonomously choose whether to provide personal information to software or hardware such as an electronic device, an applications, a server, or a storage medium that performs the operations of the technical solution of the present disclosure based on the prompt information.

As an optional but non-limiting implementation, in response to receiving the active request from the user, the approach of sending the prompt information to the user may be, for example, a pop-up window, in which the prompt information may be presented in the form of text. In addition, the pop-up window can also carry a selection control for the user to choose “agree” or “disagree” to provide personal information to the electronic device.

It may be understood that the above process of notifying and obtaining the user authorization is only illustrative and does not limit the implementation of the present disclosure. Other methods that satisfy relevant laws and regulations can also be applied to the implementation of the present disclosure.

It may be understood that the data involved in this technical solution (comprising, but not limited to, the data itself, the obtaining or use of the data) should comply with the requirements of corresponding laws and regulations and relevant provisions. Data can comprise information, parameters, messages, etc., such as stream switching instruction information.

In a first aspect, a method of experimental parameter testing is comprised in the present disclosure according to one or more embodiments of the present disclosure, comprising:
determining a traffic indicator of a target object, and obtaining a plurality of traffic indicator values of the traffic indicator from a plurality of databases;
determining, based on the plurality of traffic indicator values, a quantile indicator value corresponding to the traffic indicator;
obtaining a plurality of first ground-truth indicator values corresponding to an experimental group and a plurality of second ground-truth indicator values corresponding to a control group of a traffic indicator of the plurality of databases; and
determining a test result of the experimental parameter based on the plurality of first ground-truth indicator values, the plurality of second ground-truth indicator values and the quantile indicator value, the test result being test passed or test failed.

According to one or more embodiments of the present disclosure, determining the test result of the experimental parameter based on the plurality of first ground-truth indicator values, the plurality of second ground-truth indicator values and the quantile indicator value comprises:
calculating a first permeability indicator associated with the experimental group, to indicate a proportion of first ground-truth indicator values that satisfy a predetermined magnitude relationship with the quantile indicator value;
calculating a second permeability indicator associated with the control group, to indicate a proportion of second ground-truth indicator values that satisfy a predetermined magnitude relationship with the quantile indicator value; and
determining the test result of the experimental parameter based on the first permeability indicator and the second permeability indicator.

According to one or more embodiments of the present disclosure, calculating the first permeability indicator associated with the experimental group comprises:
obtaining the number of first ground-truth indicator values in each database and adding up the numbers of first ground-truth indicator values in the plurality of databases, to obtain a first number; determining the number of first target indicator values in each database that satisfy a predetermined magnitude relationship with the quantile indicator value, and adding up the numbers of first target indicator values in the plurality of databases, to obtain a second number; and
determining a ratio of the second number to the first number as the first permeability indicator.

According to one or more embodiments of the present disclosure, calculating a second permeability indicator associated with the control group comprises:
obtaining the number of second ground-truth indicator values in each database and adding up the numbers of second ground-truth indicator values in the plurality of databases, to obtain a third number;
determining the number of second target indicator values in each database that satisfy a predetermined magnitude relationship with the quantile indicator value, and adding up the numbers of second target indicator values in the plurality of databases, to obtain a fourth number; and
determining a ratio of the fourth number to the third number as the second permeability indicator.

According to one or more embodiments of the present disclosure, determining the test result of the experimental parameter based on the first permeability indicator and the second permeability indicator comprises:
processing the first permeability indicator and the second permeability indicator based on hypothesis testing, to obtain a P value associated with the hypothesis testing, the P value indicating whether there is a significant difference between the first permeability indicator and the second permeability indicator; and
in accordance with a determination that the P value indicates that there is a significant difference between the first permeability indicator and the second permeability indicator, determining the test result of the experimental parameter as test passed.

According to one or more embodiments of the present disclosure, determining, based on the plurality of traffic indicator values, a quantile indicator value corresponding to the traffic indicator comprises:
determining an initial indicator value;
determining, based on the initial indicator value and from the plurality of traffic indicator values, a plurality of target traffic indicator values that satisfy a predetermined magnitude relationship with the initial indicator value;
determining a fifth number of the plurality of target traffic indicator values and a sixth number of the plurality of traffic indicator values; and
determining the quantile indicator value based on the fifth number, the sixth number, a predetermined quantile, and the initial indicator value.

According to one or more embodiments of the present disclosure, determining the quantile indicator value based on the fifth number, the sixth number, the predetermined quantile and the initial indicator value comprises:
determining a ratio between the fifth number and the sixth number;
in response to determining that the ratio is equal to the predetermined quantile, determining the initial indicator value as the quantile indicator value; and
in response to determining that the ratio is not equal to the predetermined quantile, updating the initial indicator value until the ratio determined based on the updated initial indicator value is equal to the predetermined quantile, and determining the updated initial indicator value as the quantile indicator value.

According to one or more embodiments of the present disclosure, after determining the test result of the experimental parameter, the method further comprises:
if the test result is test failed, generating prompt information indicating a risk of online operation for the experimental parameter; and
sending the prompt information to a predetermined device or presenting the prompt information.

In a second aspect, an apparatus for experimental parameter testing is comprised in the present disclosure according to one or more embodiments of the present disclosure, comprising a first determination module, a first obtaining module, a second determination module, a second obtaining module, and a third determination module, wherein:
the first determination module is configured to determine a traffic indicator of a target object;
the first obtaining module is configured to obtain a plurality of traffic indicator values of the traffic indicator from a plurality of databases;
the second determination module is configured to determine, based on the plurality of traffic indicator values, a quantile indicator value corresponding to the traffic indicator;
the second obtaining module is configured to obtain a plurality of first ground-truth indicator values corresponding to an experimental group and a plurality of second ground-truth indicator values corresponding to a control group of a traffic indicator of the plurality of databases; and the third determination module is configured to determine a test result of the experimental parameter based on the plurality of first ground-truth indicator values, the plurality of second ground-truth indicator values and the quantile indicator value, the test result being test passed or test failed.

According to one or more embodiments of the present disclosure, the third determination module is specifically configured to:
calculate a first permeability indicator associated with the experimental group, to indicate a proportion of first ground-truth indicator values that satisfy a predetermined magnitude relationship with the quantile indicator value;
calculate a second permeability indicator associated with the control group, to indicate a proportion of second ground-truth indicator values that satisfy a predetermined magnitude relationship with the quantile indicator value; and
determine the test result of the experimental parameter based on the first permeability indicator and the second permeability indicator.

According to one or more embodiments of the present disclosure, the third determination module is specifically configured to:
obtain the number of first ground-truth indicator values in each database and add up the numbers of first ground-truth indicator values in the plurality of databases, to obtain a first number;
determine the number of first target indicator values in each database that satisfy a predetermined magnitude relationship with the quantile indicator value, and add up the numbers of first target indicator values in the plurality of databases, to obtain a second number; and
determine a ratio of the second number to the first number as the first permeability indicator.

According to one or more embodiments of the present disclosure, the third determination module is specifically configured to:
obtain the number of second ground-truth indicator values in each database and add up the numbers of second ground-truth indicator values in the plurality of databases, to obtain a third number; determine the number of second target indicator values in each database that satisfy a predetermined magnitude relationship with the quantile indicator value, and add up the numbers of second target indicator values in the plurality of databases, to obtain a fourth number; and determine a ratio of the fourth number to the third number as the second permeability indicator.

According to one or more embodiments of the present disclosure, the third determination module is specifically configured to:
process the first permeability indicator and the second permeability indicator based on hypothesis testing, to obtain a P value associated with the hypothesis testing, the P value indicating whether there is a significant difference between the first permeability indicator and the second permeability indicator; and
in accordance with a determination that the P value indicates that there is a significant difference between the first permeability indicator and the second permeability indicator, determine the test result of the experimental parameter as test passed.

According to one or more embodiments of the present disclosure, the second determination module is specifically configured to: determine an initial indicator value;
determine, based on the initial indicator value and from the plurality of traffic indicator values, a plurality of target traffic indicator values that satisfy a predetermined magnitude relationship with the initial indicator value;
determine a fifth number of the plurality of target traffic indicator values and a sixth number of the plurality of traffic indicator values; and
determine the quantile indicator value based on the fifth number, the sixth number, a predetermined quantile, and the initial indicator value.

According to one or more embodiments of the present disclosure, the second determination module is specifically configured to:
determine a ratio between the fifth number and the sixth number;
in response to determining that the ratio is equal to the predetermined quantile, determine the initial indicator value as the quantile indicator value; and
in response to determining that the ratio is not equal to the predetermined quantile, update the initial indicator value until the ratio determined based on the updated initial indicator value is equal to the predetermined quantile, and determine the updated initial indicator value as the quantile indicator value.

According to one or more embodiments of the present disclosure, the third determination module is further configured to:
if the test result is test failed, generate prompt information indicating a risk of online operation for the experimental parameter; and
send the prompt information to a predetermined device or present the prompt information.

In a third aspect, the present disclosure provides an electronic device comprising a processor and a memory;
the memory storing computer-executable instructions; and
the processor executing the computer-executable instructions stored in the memory, causing the processor to perform the method of experimental parameter testing according to the first aspect and as variously as may be covered in the first aspect.

In a fourth aspect, the present disclosure provides a computer-readable storage medium storing computer-executable instructions, the computer-executable instructions, when executed by a processor, implementing the method of experimental parameter testing according to the first aspect and as variously as may be covered in the first aspect.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion comprises several specific implementation details, they should not be construed as limiting the scope of the present disclosure. Some features described in the context of separate embodiments may also be realized in combination in a single embodiment. On the contrary, various features described in the context of a single embodiment may also be realized in multiple embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely example forms of realizing the claims.

1. A method of experimental parameter testing, comprising:
determining a traffic indicator of a target object, and obtaining a plurality of traffic indicator values of the traffic indicator from a plurality of databases;
determining, based on the plurality of traffic indicator values, a quantile indicator value corresponding to the traffic indicator;
obtaining a plurality of first ground-truth indicator values corresponding to an experimental group and a plurality of second ground-truth indicator values corresponding to a control group of a traffic indicator of the plurality of databases; and
determining a test result of the experimental parameter based on the plurality of first ground-truth indicator values, the plurality of second ground-truth indicator values and the quantile indicator value, the test result being test passed or test failed.

2. The method of claim 1, wherein determining the test result of the experimental parameter based on the plurality of first ground-truth indicator values, the plurality of second ground-truth indicator values and the quantile indicator value comprises:
calculating a first permeability indicator associated with the experimental group, to indicate a proportion of first ground-truth indicator values that satisfy a predetermined magnitude relationship with the quantile indicator value;
calculating a second permeability indicator associated with the control group, to indicate a proportion of second ground-truth indicator values that satisfy a predetermined magnitude relationship with the quantile indicator value; and
determining the test result of the experimental parameter based on the first permeability indicator and the second permeability indicator.

3. The method of claim 2, wherein calculating the first permeability indicator associated with the experimental group comprises:
obtaining the number of first ground-truth indicator values in each database and adding up the numbers of first ground-truth indicator values in the plurality of databases, to obtain a first number;
determining the number of first target indicator values in each database that satisfy a predetermined magnitude relationship with the quantile indicator value, and adding up the numbers of first target indicator values in the plurality of databases, to obtain a second number; and
determining a ratio of the second number to the first number as the first permeability indicator.

4. The method of claim 2, wherein calculating a second permeability indicator associated with the control group comprises:
obtaining the number of second ground-truth indicator values in each database and adding up the numbers of second ground-truth indicator values in the plurality of databases, to obtain a third number;
determining the number of second target indicator values in each database that satisfy a predetermined magnitude relationship with the quantile indicator value, and adding up the numbers of second target indicator values in the plurality of databases, to obtain a fourth number; and
determining a ratio of the fourth number to the third number as the second permeability indicator.

5. The method of claim 2, wherein determining the test result of the experimental parameter based on the first permeability indicator and the second permeability indicator comprises:
processing the first permeability indicator and the second permeability indicator based on hypothesis testing, to obtain a P value associated with the hypothesis testing, the P value indicating whether there is a significant difference between the first permeability indicator and the second permeability indicator; and
in accordance with a determination that the P value indicates that there is a significant difference between the first permeability indicator and the second permeability indicator, determining the test result of the experimental parameter as test passed.

6. The method of claim 1, wherein determining, based on the plurality of traffic indicator values, a quantile indicator value corresponding to the traffic indicator comprises:
determining an initial indicator value;
determining, based on the initial indicator value and from the plurality of traffic indicator values, a plurality of target traffic indicator values that satisfy a predetermined magnitude relationship with the initial indicator value;
determining a fifth number of the plurality of target traffic indicator values and a sixth number of the plurality of traffic indicator values; and
determining the quantile indicator value based on the fifth number, the sixth number, a predetermined quantile, and the initial indicator value.

7. The method of claim 6, wherein the determining the quantile indicator value based on the fifth number, the sixth number, the predetermined quantile and the initial indicator value comprises:
determining a ratio between the fifth number and the sixth number;
in response to determining that the ratio is equal to the predetermined quantile, determining the initial indicator value as the quantile indicator value; and
in response to determining that the ratio is not equal to the predetermined quantile, updating the initial indicator value until the ratio determined based on the updated initial indicator value is equal to the predetermined quantile, and determining the updated initial indicator value as the quantile indicator value.

8. The method of claim 1, wherein after determining the test result of the experimental parameter, the method further comprises:
if the test result is test failed, generating prompt information indicating a risk of online operation for the experimental parameter; and
sending the prompt information to a predetermined device or presenting the prompt information.

9. An electronic device, comprising a processor and a memory;
the memory storing computer-executable instructions; and
the processor executing the computer-executable instructions stored in the memory, causing the processor to perform acts comprising:
determining a traffic indicator of a target object, and obtaining a plurality of traffic indicator values of the traffic indicator from a plurality of databases;
determining, based on the plurality of traffic indicator values, a quantile indicator value corresponding to the traffic indicator;
obtaining a plurality of first ground-truth indicator values corresponding to an experimental group and a plurality of second ground-truth indicator values corresponding to a control group of a traffic indicator of the plurality of databases; and
determining a test result of the experimental parameter based on the plurality of first ground-truth indicator values, the plurality of second ground-truth indicator values and the quantile indicator value, the test result being test passed or test failed.

10. The electronic device of claim 9, wherein determining the test result of the experimental parameter based on the plurality of first ground-truth indicator values, the plurality of second ground-truth indicator values and the quantile indicator value comprises:
calculating a first permeability indicator associated with the experimental group, to indicate a proportion of first ground-truth indicator values that satisfy a predetermined magnitude relationship with the quantile indicator value;
calculating a second permeability indicator associated with the control group, to indicate a proportion of second ground-truth indicator values that satisfy a predetermined magnitude relationship with the quantile indicator value; and
determining the test result of the experimental parameter based on the first permeability indicator and the second permeability indicator.

11. The electronic device of claim 10, wherein calculating the first permeability indicator associated with the experimental group comprises:
obtaining the number of first ground-truth indicator values in each database and adding up the numbers of first ground-truth indicator values in the plurality of databases, to obtain a first number;
determining the number of first target indicator values in each database that satisfy a predetermined magnitude relationship with the quantile indicator value, and adding up the numbers of first target indicator values in the plurality of databases, to obtain a second number; and
determining a ratio of the second number to the first number as the first permeability indicator.

12. The electronic device of claim 10, wherein calculating a second permeability indicator associated with the control group comprises:
obtaining the number of second ground-truth indicator values in each database and adding up the numbers of second ground-truth indicator values in the plurality of databases, to obtain a third number;
determining the number of second target indicator values in each database that satisfy a predetermined magnitude relationship with the quantile indicator value, and adding up the numbers of second target indicator values in the plurality of databases, to obtain a fourth number; and
determining a ratio of the fourth number to the third number as the second permeability indicator.

13. The electronic device of claim 10, wherein determining the test result of the experimental parameter based on the first permeability indicator and the second permeability indicator comprises:
processing the first permeability indicator and the second permeability indicator based on hypothesis testing, to obtain a P value associated with the hypothesis testing, the P value indicating whether there is a significant difference between the first permeability indicator and the second permeability indicator; and
in accordance with a determination that the P value indicates that there is a significant difference between the first permeability indicator and the second permeability indicator, determining the test result of the experimental parameter as test passed.

14. The electronic device of claim 9, wherein determining, based on the plurality of traffic indicator values, a quantile indicator value corresponding to the traffic indicator comprises:
determining an initial indicator value;
determining, based on the initial indicator value and from the plurality of traffic indicator values, a plurality of target traffic indicator values that satisfy a predetermined magnitude relationship with the initial indicator value;
determining a fifth number of the plurality of target traffic indicator values and a sixth number of the plurality of traffic indicator values; and
determining the quantile indicator value based on the fifth number, the sixth number, a predetermined quantile, and the initial indicator value.

15. The electronic device of claim 14, wherein the determining the quantile indicator value based on the fifth number, the sixth number, the predetermined quantile and the initial indicator value comprises:
determining a ratio between the fifth number and the sixth number;
in response to determining that the ratio is equal to the predetermined quantile, determining the initial indicator value as the quantile indicator value; and
in response to determining that the ratio is not equal to the predetermined quantile, updating the initial indicator value until the ratio determined based on the updated initial indicator value is equal to the predetermined quantile, and determining the updated initial indicator value as the quantile indicator value.

16. The electronic device of claim 9, wherein after determining the test result of the experimental parameter, the method further comprises:
if the test result is test failed, generating prompt information indicating a risk of online operation for the experimental parameter; and
sending the prompt information to a predetermined device or presenting the prompt information.

17. A non-transitory computer-readable storage medium, wherein computer-executable instructions are stored in the computer-readable storage medium, the computer-executable instructions, when executed by a processor, implementing acts comprising:
determining a traffic indicator of a target object, and obtaining a plurality of traffic indicator values of the traffic indicator from a plurality of databases;
determining, based on the plurality of traffic indicator values, a quantile indicator value corresponding to the traffic indicator;
obtaining a plurality of first ground-truth indicator values corresponding to an experimental group and a plurality of second ground-truth indicator values corresponding to a control group of a traffic indicator of the plurality of databases; and
determining a test result of the experimental parameter based on the plurality of first ground-truth indicator values, the plurality of second ground-truth indicator values and the quantile indicator value, the test result being test passed or test failed.

18. The non-transitory computer-readable storage medium of claim 17, wherein determining the test result of the experimental parameter based on the plurality of first ground-truth indicator values, the plurality of second ground-truth indicator values and the quantile indicator value comprises:
calculating a first permeability indicator associated with the experimental group, to indicate a proportion of first ground-truth indicator values that satisfy a predetermined magnitude relationship with the quantile indicator value;
calculating a second permeability indicator associated with the control group, to indicate a proportion of second ground-truth indicator values that satisfy a predetermined magnitude relationship with the quantile indicator value; and
determining the test result of the experimental parameter based on the first permeability indicator and the second permeability indicator.

19. The non-transitory computer-readable storage medium of claim 18, wherein calculating the first permeability indicator associated with the experimental group comprises:
obtaining the number of first ground-truth indicator values in each database and adding up the numbers of first ground-truth indicator values in the plurality of databases, to obtain a first number;
determining the number of first target indicator values in each database that satisfy a predetermined magnitude relationship with the quantile indicator value, and adding up the numbers of first target indicator values in the plurality of databases, to obtain a second number; and
determining a ratio of the second number to the first number as the first permeability indicator.

20. A non-transitory computer-readable storage medium of claim 18, wherein calculating a second permeability indicator associated with the control group comprises:
obtaining the number of second ground-truth indicator values in each database and adding up the numbers of second ground-truth indicator values in the plurality of databases, to obtain a third number;
determining the number of second target indicator values in each database that satisfy a predetermined magnitude relationship with the quantile indicator value, and adding up the numbers of second target indicator values in the plurality of databases, to obtain a fourth number; and
determining a ratio of the fourth number to the third number as the second permeability indicator.
